(19) United States
(12) Patent Application Publication
(10) Pub. No.: US 2014/0337980 A1
(43) Pub. Date: Nov. 13, 2014

(54) METHOD, DEVICE AND TERMINAL FOR SCANNING VIRUS

(71) Applicant: TENCENT TECHNOLOGY (SHENZHEN) COMPANY LIMITED, Shenzhen (CN)

(72) Inventor: Jiahui LIANG, Shenzhen (CN)

(73) Assignee: TENCENT TECHNOLOGY (SHENZHEN) COMPANY LIMITED, Shenzhen (CN)

(21) Appl. No.: 14/339,615

(22) Filed: Jul. 24, 2014

Related U.S. Application Data
(63) Continuation of application No. PCT/CN2014/073552, filed on Mar. 17, 2014.

(30) Foreign Application Priority Data
Mar. 20, 2013 (CN) 201310090075.9

(51) Int. Cl. H04L 29/06; G06F 9/445

(52) U.S. Cl. CPC H04L 63/1416; H04L 63/145; G06F 8/62
USPC 726/24

(57) ABSTRACT

Described are a method and a device for processing price, a method and an electronic commerce system for processing order sheet. The method for processing price includes: obtaining attribute information of a commodity in an electronic commerce system; distributing a charging mark to the commodity according to the attribute information of the commodity; and setting price information corresponding to the charging mark of the commodity according to a predetermined price processing rule. The information price of the commodity is pertinently customized according to the attribute information of the electronic commerce system. The commodity of the electronic commerce system is strong pertinence that price may be adjusted flexibly and efficiently, and an intelligence of the electronic commerce system is improved.

### CROSS-REFERENCE TO RELATED APPLICATIONS

This is a U.S. continuation application under 35 U.S.C. §111(a) claiming priority under 35 U.S.C. §§120 and 365(c) to International Application No. PCT/CN2014/073552 filed on Mar. 17, 2014, which claims the priority benefit of Chinese Patent Application NO. 201310090075.9 filed on Mar. 20, 2013, the contents of which are incorporated by reference herein in their entirety for all intended purposes.

### FIELD OF THE TECHNICAL

The disclosure relates to the field of internet technology, specifically to the field of terminal technology and particularly to methods, devices and terminals for scanning virus.

### BACKGROUND

This section provides background information related to the present disclosure which is not necessarily prior art.

As the development of the terminal technology, the terminal security problem becomes increasingly severe. A method for scanning virus performs an important role on protecting the terminal security. Nowadays, a common method for scanning virus on an installation package of the terminal may include enabling a virus scan on a file, and the file is formed during the installation package being installed. However, if a virus is found during the virus scan, a user needs to perform an anti-virus scan process manually to clear the file which contains the virus, and thus the intelligence of virus scanning may be reduced. Since the installation package has been installed, the virus may have infected other files in the terminal system, and thus the security of the terminal system may be reduced.

### SUMMARY

Exemplary embodiments of the present invention provide methods, devices and terminals for scanning virus, in which virus scanning and processing can be realized before the installation package in the terminal is installed, and the intelligence of virus scanning and security of the terminal system can be improved.

One embodiment of the present invention provides a method for scanning virus, which includes: monitoring an installation event in a terminal system, and obtaining information of an installation package which generates the installation event when the installation event in the terminal system is detected; performing a virus scan on the information of the installation package to obtain a scan result; and jumping to a processing interface to process the installation event according to the scan result.

Another embodiment of the present invention provides a device for scanning virus, which includes: a monitoring module configured to monitor an installation event in a terminal system and obtain information of an installation package which generates the installation event when the installation event in the terminal system is detected; a virus scanning module configured to perform a virus scan on the information of the installation package to obtain a scan result; and a processing module configured to jump to a processing interface to process the installation event according to the scan result.

Yet another embodiment of the present invention provides a system for scanning virus which includes the device for scanning virus described above.

Exemplary embodiments of the present invention may have the following beneficial effects.

In exemplary embodiments of the present invention, when an installation event in a terminal system is detected, information of an installation package which generates the installation event can be obtained, and a virus scan can be performed on the information of the installation package. The installation event can be processed according to a scan result. In this manner, the virus scanning and the scan result processing can be accomplished before the installation package is installed in the terminal. Thus, the intelligence of the virus scanning and the security of the terminal system can be relatively improved.

### BRIEF DESCRIPTION OF THE DRAWINGS

In order to illustrate the embodiments or existing technical solutions more clearly, a brief description of drawings that assists the description of embodiments of the invention or existing art will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of a method for scanning virus according to one embodiment of the invention.

FIG. 2 is a flowchart of a method for scanning virus according to another embodiment of the invention.

FIG. 3 is a block diagram of a device for scanning virus according to one embodiment of the invention.

FIG. 4 is a block diagram of a device for scanning virus according to another embodiment of the invention.

FIG. 5 is a block diagram of a virus scanning module of a device according to one embodiment of the invention.

FIG. 6 is a block diagram of a processing module of a device according to one embodiment of the invention.

### DETAILED DESCRIPTION OF ILLUSTRATED EMBODIMENTS

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In one embodiment of the present invention, a terminal can include, but is not limited to, a personal computer (PC), a panel computer, a mobile phone, a smart phone, a laptop computer, etc. A terminal system can be an operating system of the terminal, which can include, but is not limited to, a windows system, an android system, an internet operating system (IOS), etc.

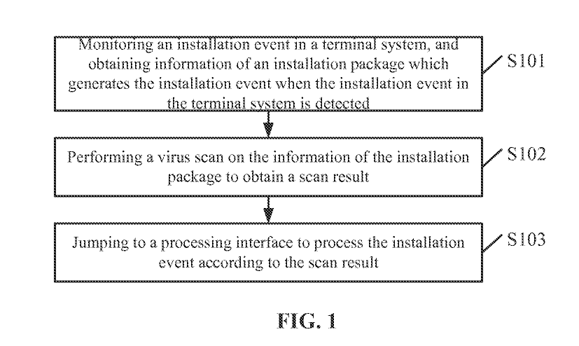

Referring to FIG. 1, it is a flowchart of a method for scanning virus according to one embodiment of the invention. The method includes following steps S101-S103.

Step S101, monitoring an installation event in a terminal system, and obtaining information of an installation package which generates the installation event when the installation event in the terminal system is detected.

In this step, the installation event in the terminal system can be monitored by a monitoring program. The conventional monitoring program usually needs to obtain a monitoring permission before it can monitor the installation event in the terminal system. For example, if the monitoring program needs to monitor an android system, a root permission of the android system should be obtained before the installation event can be monitored. A conventional monitoring process based on the monitoring permission may be a complex procedure, and the generality and the compatibility of which can be relatively low. In one embodiment of the present invention, in order to realize the purpose of normal monitoring without a complex procedure of obtaining the monitoring permission, the configuration of the monitoring program may be referred for the a format and a compile mode of a source code in the terminal system. For example, for the monitoring program of the android system, one may refer to the format and the compile mode of “PackageInstallerActivity” in the source code “\packages\apps\PackageInstaller\AndroidManifest.xml” of the android system. In this step, when the installation event of the terminal system is detected, the monitoring program can obtain the information of the installation package which generates the installation event. The information of the installation package can include, but is not limited to, information, such as a name, a size, a data character, etc., of the installation package.

Step S102, performing a virus scan on the information of the installation package to obtain a scan result.

In this step, a virus scan program can be called to perform the virus scan on the information of the installation package to obtain the scan result. It should be noted that a virus scan result can be obtained if a virus contained in the information of the installation package is found during the virus scan process, or a security scan result can be obtained if no virus contained in the information of the installation package is found during the virus scan process.

Step S103, jumping to a processing interface to process the installation event according to the scan result.

The processing interface can include an anti-virus scan processing interface and an installation interface of the terminal system. If the scan result is the virus scan result, this step can specifically be jumping to an anti-virus scan processing interface to perform the anti-virus scan; if the scan result is the security scan result, this step can specifically be jumping to the installation interface of the terminal system to install the installation package which generates the installation event.

In exemplary embodiments of the present invention, when an installation event in a terminal system is detected, information of an installation package which generates the installation event can be obtained, and a virus scan can be performed on the information of the installation package. The installation event can be processed according to a scan result. In this manner, the virus scanning and the scan result processing can be accomplished before the installation package is installed in the terminal. Thus, the intelligence of the virus scanning and the security of the terminal system can be relatively improved.

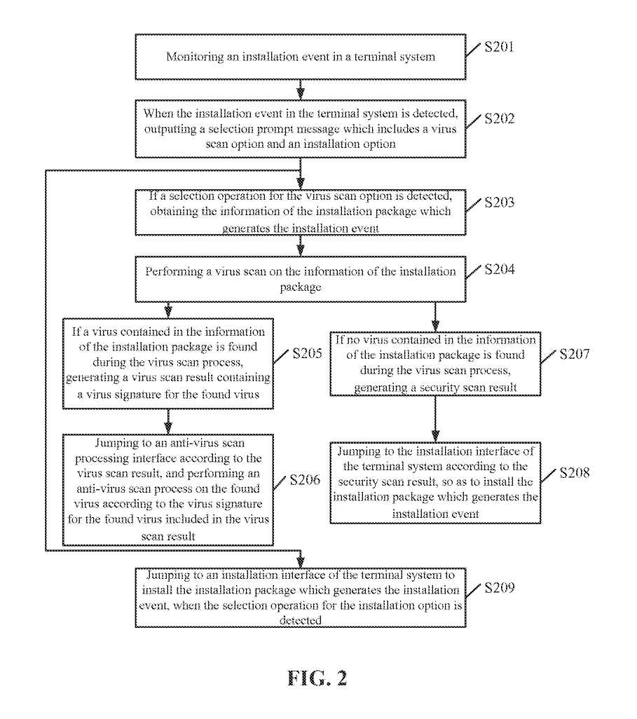

Referring to FIG. 2, it is a flowchart of a method for scanning virus according to another embodiment of the invention. The method includes the following steps S201-S209.

Step S201, monitoring an installation event in a terminal system.

In this step, the installation event in the terminal system can be monitored by a monitoring program. The conventional monitoring program usually needs to obtain a monitoring permission before it can monitor the installation event in the terminal system. For example, if the monitoring program needs to monitor an android system, a root permission of the android system should be obtained before the installation event can be monitored. A conventional monitoring process based on the monitoring permission may be a complex procedure, and the generality and the compatibility of which can be relatively low. In one embodiment of the present invention, in order to realize the purpose of normal monitoring without a complex procedure of obtaining the monitoring permission, the configuration of the monitoring program may be referred for the a format and a compile mode of a source code in the terminal system. For example, for the monitoring program of the android system, one may refer to the format and the compile mode of “PackageInstallerActivity” in the source code “\packages\apps\PackageInstaller\AndroidManifest.xml” of the android system.

Step S202, when the installation event in the terminal system is detected, outputting a selection prompt message which includes a virus scan option and an installation option; if a selection operation for the virus scan option or the installation option is detected, jumping to step S203 or step S209.

In this step, when the monitoring program detects the installation event in the terminal system, it can prompt a user to select to continue the installation event or to perform the virus scan before the installation, which means that it can output the selection prompt message for the user. The selection prompt message can include the virus scan option and the installation option. If the virus scan option selected by the user is detected, which indicates that the user selects to perform the virus scan before the installation, it can jump to step S203 to execute the subsequent flow; if the installation option selected by the user is detected, which indicates that the user selects to continue the installation event, it can jump to step S209 to execute the subsequent flow.

Step S203, if a selection operation for the virus scan option is detected, obtaining the information of the installation package which generates the installation event.

If the selection operation for the virus scan option is detected, it indicates that the user selects to perform the virus scan before the installation. The monitoring program can obtain the information of the installation package which generates the installation event, and send the information of the installation package to the virus scan program, which may be triggered to perform a virus scan on the information of the installation package.

Step S204, performing a virus scan on the information of the installation package; if a virus is found during the virus scan process, jumping to step S205; if no virus is found during the virus scan process, jumping to step S207.

After the virus scan program receives the information of the installation package sent by the monitoring program, it performs the virus scan on the information of the installation package. If a virus is found during the virus scan process, which indicates that the installation package may have a hidden security risk, it can jump to step S205 for the subsequent process; if no virus is found during the virus scan process, which indicates that the installation package may be safe, it can jump to step S207 for the subsequent process.

Step S205, if a virus contained in the information of the installation package is found during the virus scan process, generating a virus scan result containing a virus signature for the found virus.

Step S206, jumping to an anti-virus scan processing interface according to the virus scan result, and performing an anti-virus scan process on the found virus according to the virus signature for the found virus included in the virus scan result. Then the flow may come to an end.

Before the anti-virus scan process is executed, the anti-virus scan processing interface can also output an inquiry message to inquiry whether the user needs to perform the anti-virus scan. If the user confirms to perform the anti-virus scan, it can be performed on the found virus according to the virus signature for the found virus which is included in the virus scan result; if the user refuses to perform the anti-virus scan, the anti-virus scan processing interface may be exit.

Step S207, if no virus contained in the information of the installation package is found during the virus scan process, generating a security scan result.

Step S208, jumping to the installation interface of the terminal system according to the security scan result, so as to install the installation package which generates the installation event. Then the flow may come to the end.

Before the installation is executed, the installation interface of the terminal system can also output an inquiry message to inquiry whether the user needs to install the installation package; if the user confirms to install, the installation package which generates the installation event can be installed; if the user refuses to install, the installation interface of the terminal system may be exit.

Step S209, jumping to an installation interface of the terminal system to install the installation package which generates the installation event, when the selection operation for the installation option is detected. Then the flow may come to the end.

If the selection operation from the user for the installation option is detected, which indicates that the user selects to continue the installation event, it can jump to the installation interface of the terminal system to install the installation package which generates the installation event. Optionally, before the installation interface of the terminal system performs the installation, it can also output an inquiry message to inquiry whether the user needs to install the installation package. If the user confirms to install, the installation package which generates the installation event can be installed. If the user refuses to install, the installation interface of the terminal system may be exit.

In exemplary embodiments of the present invention, when an installation event in a terminal system is detected, information of an installation package which generates the installation event can be obtained, and a virus scan can be performed on the information of the installation package. The installation event can be processed according to a scan result. In this manner, the virus scanning and the scan result processing can be accomplished before the installation package is installed in the terminal. Thus, the intelligence of the virus scanning and the security of the terminal system can be relatively improved.

Take a specific example to illustrate the method for scanning virus in combination with FIGS. 1-2.

It is assumed that the terminal can be a mobile phone and the terminal system can be an android system. The specific flow of the method for scanning virus according to one embodiment of the present invention can be described as below.

An installation event in the android system may be monitored in real time, when a user selects an Android Package (APK) to be installed, it may trigger the installation event. After the installation event triggered by the APK is detected, a selection box may be popped up, in which a virus scan option and an installation option can be outputted to prompt the user to select.

If the user selects the virus scan option, APK information may be obtained, and a virus scan program may be called to perform a virus scan on the APK information. If a virus is found during the virus scan process, a virus scan result may be generated. And an anti-virus scan processing interface can be jumped to, in which a prompt box may be shown to inquiry whether the user needs to perform the anti-virus scan. When the user confirms to perform the anti-virus scan, it can be performed on the found virus according to the virus signature for the found virus in the virus scan result; when the user refuses to perform the anti-virus scan, the anti-virus scan processing interface may be exit. If no virus is found during the virus scan process, a security scan result may be generated. And a prompt box in an installation interface of the terminal system may be shown to inquiry whether the user needs to install. When the user confirms to install, the APK may be installed; when the user refuses to install, the installation interface of the terminal system may be exit.

If the user selects the installation option, the installation interface of the terminal system may be jumped to, in which the prompt box may inquiry whether the user needs to install. When the user confirms to install, the APK can be installed; when the user refuses to install, the installation interface of the terminal system may be exit.

In exemplary embodiments of the present invention, when an installation event in a terminal system is detected, information of an installation package which generates the installation event can be obtained, and a virus scan can be performed on the information of the installation package. The installation event can be processed according to a scan result. In this manner, the virus scanning and the scan result processing can be accomplished before the installation package is installed in the terminal. Thus, the intelligence of the virus scanning and the security of the terminal system can be relatively improved.

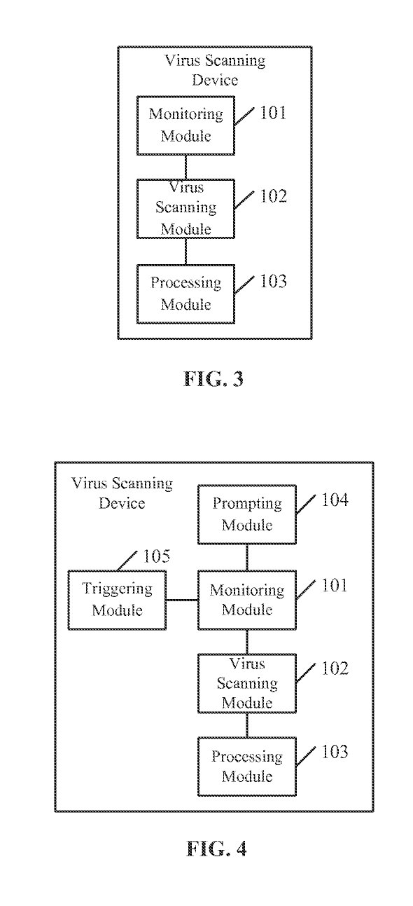

A structure of a device for scanning virus according to one embodiment of the present invention can be illustrated in combination of FIGS. 3-6. It should be noted that a device shown in any one of FIGS. 3-6 is used to execute a method shown in any one of FIGS. 1-2. It can be illustrated only with parts relating to one embodiment of the present invention for convenience, one may refer to other specific technical details with the reference of FIGS. 1-2.

Referring to FIG. 3, it is a block diagram of a device for scanning virus according to one embodiment of the invention. The device includes: a monitoring module 101, a virus scanning module 102, and a processing module 103.

The monitoring module 101 is configured to monitor an installation event in a terminal system, and obtain information of an installation package which generates the installation event when the installation event in the terminal system is detected.

The monitoring module 101 can be a section of a monitoring program, which is used to monitor the installation event in the terminal system. The conventional monitoring program usually needs to obtain a monitoring permission before it can monitor the installation event in the terminal system. For example, if the monitoring program needs to monitor an android system, a root permission of the android system should be obtained before the installation event can be monitored. A conventional monitoring process based on the monitoring permission may be a complex procedure, and the generality and the compatibility of which can be relatively low. In one embodiment of the present invention, in order to realize the purpose of normal monitoring without a complex procedure of obtaining the monitoring permission, the configuration of the monitoring program may be referred for the a format and a compile mode of a source code in the terminal system. For example, for the monitoring program of the android system, one may refer to the format and the compile mode of “PackageInstallerActivity” in the source code “\packages\apps\PackageInstaller\AndroidManifest.xml” of the android system. When the installation event of the terminal system is detected, the monitoring module 101 can obtain the information of the installation package which generates the installation event. The information of the installation package can include, but is not limited to, information, such as a name, a size, a data character, etc., of the installation package.

The virus scanning module 102 is configured to perform a virus scan on the information of the installation package to obtain a scan result.

The virus scanning module 102 can be a virus scan program, which is used to perform the virus scan on the information of the installation package to obtain a scan result. It should be noted that a virus scan result can be obtained if a virus contained in the information of the installation package is found during the virus scan process, or a security scan result can be obtained if no virus contained in the information of the installation package is found during the virus scan process.

The processing module 103 is configured to jump to a processing interface to process the installation event according to the scan result.

The processing interface can include an anti-virus scan processing interface and an installation interface of the terminal system. If the scan result is the virus scan result, the processing module 103 can jump to an anti-virus scan processing interface to perform the anti-virus scan; if the scan result is the security scan result, the processing module 103 can jump to the installation interface of the terminal system to install the installation package which generates the installation event.

In exemplary embodiments of the present invention, when an installation event in a terminal system is detected, information of an installation package which generates the installation event can be obtained, and a virus scan can be performed on the information of the installation package. The installation event can be processed according to a scan result. In this manner, the virus scanning and the scan result processing can be accomplished before the installation package is installed in the terminal. Thus, the intelligence of the virus scanning and the security of the terminal system can be relatively improved.

Referring to FIG. 4, it is a block diagram of a device for scanning virus according to another embodiment of the invention. The device includes a monitoring module 101, a virus scanning module 102, a processing module 103, a prompting module 104 and a triggering module 105. For the structure of the monitoring module 101, the virus scanning module 102 and the processing module 103, one may refer to the relative descriptions shown in FIG. 3.

The prompting module 104 is configured to output a selection prompt message which includes a virus scan option and an installation option when the monitoring module 101 detects the installation event in the terminal system.

When the installation event in the terminal system is monitored, the prompting module 104 can prompt a user to select to continue the installation event or to perform a virus scan before the installation, which means that it can output the selection prompt message for the user. The selection prompt message can include the virus scan option and the installation option. If the virus scan option selected by the user is detected, it indicates that the user selects to perform the virus scan before the installation; if the installation option selected by the user is detected, it indicates that the user selects to continue the installation event.

The triggering module 105 is configured to trigger the monitoring module 101 to obtain the information of the installation package which generates the installation event; or jump to an installing interface of the terminal system to trigger the installation package which generates the installation event to be installed when a selection operation for the installation option is detected.

If the selection operation for the virus scan option is detected, it indicates that the user selects to perform the virus scan before the installation. The triggering module 105 can trigger the monitoring module 101 to obtain the information of the installation package which generates the installation event. If the selection operation for the installation option from the user is detected, it indicates that the user selects to continue the installation event. The triggering module 105 can jump to the installation interface of the terminal system to trigger the installation package which generates the installation event to be installed.

In exemplary embodiments of the present invention, when an installation event in a terminal system is detected, information of an installation package which generates the installation event can be obtained, and a virus scan can be performed on the information of the installation package. The installation event can be processed according to a scan result. In this manner, the virus scanning and the scan result processing can be accomplished before the installation package is installed in the terminal. Thus, the intelligence of the virus scanning and the security of the terminal system can be relatively improved.

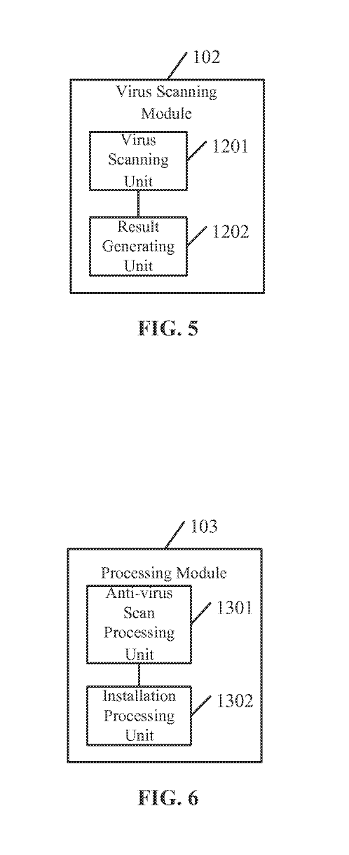

A module in a device for scanning virus according to one embodiment of the present invention would be illustrated with the reference of FIGS. 5-6.

Referring to FIG. 5, it is a block diagram of a virus scanning module of a device according to one embodiment of the present invention. The virus scanning module 102 can include: a virus scanning unit 1201 and a result generating unit 1202.

The virus scanning unit 1201 is configured to perform a virus scan on the information of the installation package.

After the virus scanning unit 1201 receives the information of the installation package, it performs the virus scan on the information of the installation package. If a virus is found during the virus scan process, it indicates that the installation package may have a hidden security risk; if no virus is found during the virus scan process, it indicates that the installation package may be safe.

The result generating unit 1202 is configured to, if a virus contained in the information of the installation package is found during the virus scan process, generate a virus scan result containing a virus signature for the found virus; or configured to, if no virus contained in the information of the installation package is found during the virus scan process, generate a security scan result.

In exemplary embodiments of the present invention, when an installation event in a terminal system is detected, information of an installation package which generates the installation event can be obtained, and a virus scan can be performed on the information of the installation package. The installation event can be processed according to a scan result. In this manner, the virus scanning and the scan result processing can be accomplished before the installation package is installed in the terminal. Thus, the intelligence of the virus scanning and the security of the terminal system can be relatively improved.

Referring to FIG. 6, it is a structure diagram of a processing module of a device according to one embodiment of the present invention. The processing module 103 can include: an anti-virus scan processing unit 1301 and an installation processing unit 1302.

The anti-virus scan processing unit 1301 is configured to jump to an anti-virus scan processing interface according to the virus scan result and perform an anti-virus scan process on the found virus according to the virus signature for the found virus which is included in the virus scan result.

Optionally, after the anti-virus scan processing unit 1301 jumps to the anti-virus scan processing interface and before it performs the anti-virus scan process, it can also output an inquiry message to inquiry whether the user needs to perform the anti-virus scan. If the user confirms to perform the anti-virus scan, it can be performed on the found virus according to the virus signature for the found virus which is included in the virus scan result; if the user refuses to perform the anti-virus scan, the anti-virus scan processing interface can be exit.

The installation processing unit 1302 is configured to jump to the installation interface of the terminal system according to the security scan result, so as to install the installation package which generates the installation event.

Optionally, after the installation processing unit 1302 jumps to the installation interface of the terminal system and before the installation is executed, it can also output an inquiry message to inquiry whether the user needs to install the installation package. If the user confirms to install the installation package, the installation package which generates the installation event can be installed; if the user refuses to install the installation package, the installation interface of the terminal system may be exit.

In exemplary embodiments of the present invention, when an installation event in a terminal system is detected, information of an installation package which generates the installation event can be obtained, and a virus scan can be performed on the information of the installation package. The installation event can be processed according to a scan result. In this manner, the virus scanning and the scan result processing can be accomplished before the installation package is installed in the terminal. Thus, the intelligence of the virus scanning and the security of the terminal system can be relatively improved.

It should be noted that a structure and a function of a device shown in any one of FIGS. 3-6 can specifically realized by a method shown in any one of FIGS. 1-2. For the specific process, one may refer to the relative descriptions according to one embodiment in combination with FIGS. 1-2.

A terminal is also disclosed according to one embodiment of the present invention, including a device for scanning virus. For a structure and a function of the device for scanning virus, one may refer to the relative descriptions according to one embodiment in combination with FIGS. 3-6. It can be understood that the terminal may also include an operating system.

Based on the descriptions above, in exemplary embodiments of the present invention, when an installation event in a terminal system is detected, information of an installation package which generates the installation event can be obtained, and a virus scan can be performed on the information of the installation package. The installation event can be processed according to a scan result. In this manner, the virus scanning and the scan result processing can be accomplished before the installation package is installed in the terminal. Thus, the intelligence of the virus scanning and the security of the terminal system can be relatively improved.

The methods, the server, the apparatus, and the system in accordance with various embodiments can be accomplished using a program/software to instruct related hardware. The hardware can include any suitable universal hardware, or any suitable specialized hardware including, e.g., specialized integrated circuits, specialized central processing unit (CPU), specialized memory, specialized components, etc. For example, the hardware can include personal computer, server, network device, etc. The program/software can be stored in a computer-readable storage medium including, e.g., ROM/RAM, magnetic disk, optical disk, etc.

The embodiments described above are merely preferred ones of the present disclosure but are not limitations to the protection scope of the present disclosure, and any variations or substitutions easily devised by those skilled in the art without departing from the spirit of the present disclosure fall within the scope of the protection. Therefore, the protection scope of the present disclosure shall be subject to that specified by the appended claims.

What is claimed is:

1. A method for scanning virus, the method comprising:
monitoring an installation event in a terminal system, and obtaining information of an installation package which generates the installation event when the installation event in the terminal system is detected;
performing a virus scan on the information of the installation package to obtain a scan result; and
jumping to a processing interface to process the installation event according to the scan result.

2. The method of claim 1, before the step of monitoring the installation event in the terminal system and obtaining the information of the installation package which generates the installation event when the installation event in the terminal system is detected, comprising:
outputting a selection prompt message which comprises a virus scan option and an installation option; and
executing the step of obtaining the information of the installation package which generates the installation event, if a selection operation for the virus scan option is detected.

3. The method of claim 2, after the step of outputting the selection prompt message, comprising:
jumping to an installation interface of the terminal system to install the installation package which generates the installation event, when a selection operation for the installation option is detected.

4. The method of claim 1, the step of performing a virus scan on the information of the installation package to obtain a scan result further comprising:
performing the virus scan on the information of the installation package;
if a virus contained in the information of the installation package is found during the virus scan process, generating a virus scan result containing a virus signature for the found virus;
if no virus contained in the information of the installation package is found during the virus scan process, generating a security scan result.

5. The method of claim 4, the step of jumping to the processing interface to process the installation event according to the scan result further comprising:
jumping to an anti-virus scan processing interface according to the virus scan result, and performing an anti-virus scan process on the found virus according to the virus signature for the found virus which is contained in the virus scan result; or
jumping to the installation interface of the terminal system according to the security scan result to install the installation package which generates the installation event.

6. A device for scanning virus, comprising:
a monitoring module, configured to monitor an installation event in a terminal system and obtain information of an installation package which generates the installation event when the installation event in the terminal system is detected;
a virus scanning module, configured to perform a virus scan on the information of the installation package to obtain a scan result; and
a processing module, configured to jump to a processing interface to process the installation event according to the scan result.

7. The device of claim 6, further comprising:
a prompting module, configured to output a selection prompt message which comprises a virus scan option and an installation option when the monitoring module detects the installation event in the terminal system; and
a triggering module, configured to trigger the monitoring module to obtain the information of the installation package which generates the installation event.

8. The device of claim 7, wherein the triggering module jumps to an installation interface of the terminal system to install the installation package which generates the installation event, when a selection operation for the installation option is detected.

9. The device of claim 6, wherein the virus scanning module comprises:
a virus scanning unit, configured to perform the virus scan on the information of the installation package; and
a result generating unit, configured to, if a virus contained in the information of the installation package is found during the virus scan process, generate a virus scan result containing a virus signature for the found virus; or configured to, if no virus contained in the information of the installation package is found during the virus scan process, generate a security scan result.

10. The device of claim 9, wherein the processing module comprises:
an anti-virus scan processing unit, configured to jump to an anti-virus scan processing interface according to the virus scan result and perform an anti-virus scan process on the found virus according to the virus signature for the found virus which is contained in the virus scan result; and
an installation processing unit configured to jump to the installation interface of the terminal system according to the security scan result, so as to install the installation package which generates the installation event.

11. A terminal, comprising a device for scanning virus, the device comprising:
a monitoring module, configured to monitor an installation event in a terminal system and obtain information of an installation package which generates the installation event when the installation event in the terminal system is detected;
a virus scanning module, configured to perform a virus scan on the information of the installation package to obtain a scan result; and
a processing module, configured to jump to a processing interface to process the installation event according to the scan result.

12. The method of claim 2, the step of performing a virus scan on the information of the installation package to obtain a scan result further comprising:
performing the virus scan on the information of the installation package;
if a virus contained in the information of the installation package is found during the virus scan process, generating a virus scan result containing a virus signature for the found virus;
if no virus contained in the information of the installation package is found during the virus scan process, generating a security scan result.

13. The method of claim 3, the step of performing a virus scan on the information of the installation package to obtain a scan result further comprising:
performing the virus scan on the information of the installation package;
if a virus contained in the information of the installation package is found during the virus scan process, generating a virus scan result containing a virus signature for the found virus;
if no virus contained in the information of the installation package is found during the virus scan process, generating a security scan result.

14. The device of claim 7, wherein the virus scanning module comprises:
a virus scanning unit, configured to perform the virus scan on the information of the installation package; and
a result generating unit, configured to, if a virus contained in the information of the installation package is found during the virus scan process, generate a virus scan result containing a virus signature for the found virus; or configured to, if no virus contained in the information of the installation package is found during the virus scan process, generate a security scan result.

15. The device of claim 8, wherein the virus scanning module comprises:
a virus scanning unit, configured to perform the virus scan on the information of the installation package; and
a result generating unit, configured to, if a virus contained in the information of the installation package is found during the virus scan process, generate a virus scan result containing a virus signature for the found virus; or configured to, if no virus contained in the information of the installation package is found during the virus scan process, generate a security scan result.

16. The terminal of claim 11, wherein the device further comprises:
a prompting module, configured to output a selection prompt message which comprises a virus scan option and an installation option when the monitoring module detects the installation event in the terminal system; and
a triggering module, configured to trigger the monitoring module to obtain the information of the installation package which generates the installation event.

17. The terminal of claim 16, wherein the triggering module jumps to an installation interface of the terminal system to install the installation package which generates the installation event, when a selection operation for the installation option is detected.

18. The terminal of claim 11, wherein the virus scanning module comprises:
a virus scanning unit, configured to perform the virus scan on the information of the installation package; and
a result generating unit, configured to, if a virus contained in the information of the installation package is found during the virus scan process, generate a virus scan result containing a virus signature for the found virus; or configured to, if no virus contained in the information of the installation package is found during the virus scan process, generate a security scan result.

19. The terminal of claim 16, wherein the virus scanning module comprises:
a virus scanning unit, configured to perform the virus scan on the information of the installation package; and
a result generating unit, configured to, if a virus contained in the information of the installation package is found during the virus scan process, generate a virus scan result containing a virus signature for the found virus; or configured to, if no virus contained in the information of the installation package is found during the virus scan process, generate a security scan result.

20. The terminal of claim 17, wherein the virus scanning module comprises:
a virus scanning unit, configured to perform the virus scan on the information of the installation package; and
a result generating unit, configured to, if a virus contained in the information of the installation package is found during the virus scan process, generate a virus scan result containing a virus signature for the found virus; or configured to, if no virus contained in the information of the installation package is found during the virus scan process, generate a security scan result.
